(19) United States
(12) Patent Application Publication
(10) Pub. No.: US 2026/0307509 A1
(43) Pub. Date: Oct. 8, 2026

(54) OPERATING MODES OF AN ELECTRIC CRANE

(71) Applicant: Manitowoc Crane Group France SAS, Dardilly (FR)

(72) Inventor: Andreas Krug, Oldenburg (DE)

(21) Appl. No.: 19/636,621

(22) Filed: Apr. 1, 2026

(30) Foreign Application Priority Data
Apr. 4, 2025 (DE) 102025113379.4

(51) Int. Cl. B60L 50/61; B60L 9/00; B60L 15/20; B60L 50/11; B60L 58/26; B60L 58/27; B66C 13/22

(52) U.S. Cl. CPC B60L 50/61; B60L 9/00; B60L 15/20; B60L 50/11; B60L 58/26; B60L 58/27; B66C 13/22; B60L 2200/40; B60L 2240/54

(57) ABSTRACT

The present disclosure includes a method for charging a battery of a mobile crane while the mobile crane is driving, wherein the mobile crane includes an internal combustion engine, the energy of which is used to drive the mobile crane and to charge the battery of the mobile crane by means of a generator, wherein the desired state of charge (SoC) of the battery when the mobile crane arrives at its destination is defined and the charging power rating required of the internal combustion engine for charging the battery is calculated and provided to the generator such that the battery can be charged, starting from its current state of charge, such that the desired state of charge of the battery is available at the calculated arrival time of the mobile crane.

### FIELD OF THE DISCLOSURE

The present disclosure relates to a crane, for example a mobile crane, including at least one electric drive and to possible operating modes of the same. The electrical energy for operating the at least one electric drive can for example be obtained from one or more batteries which are carried in or on the crane and can be charged in different ways.

### BACKGROUND

In an electric or hybrid crane, for example, a high-voltage (HV) battery can be provided which can be a high-performance rechargeable battery having a voltage of for example over 60 volts or for example even 200V up to over 800V. The HV battery can serve as the primary energy source for the electric drive and can store energy, for example for driving and normally operating the mobile crane, wherein said battery can for example be a lithium-ion battery.

The HV battery can be cooled or heated by a thermal management system in order to protect it from overheating and to keep it within the range of optimum operating temperatures.

An example of a system architecture of a mobile crane is shown in FIG. 1, in which the HV battery is denoted as “battery”.

### SUMMARY

One or more low-voltage (LV) batteries (up to 60 volts, for example 12V, 24V or 48V; not shown in FIG. 1) which is/are for example provided in the mobile crane can be charged by an HV battery as described above, which has been charged externally or internally. The rechargeable low-voltage battery/batteries can be used in the mobile crane for example as the on-board mains supply or for supplying other electric consumers such as lights, control devices and electric servo systems or for starting an internal combustion engine. Where reference is made (in general) to a battery in this document, this refers to the HV battery described above, unless otherwise indicated.

In an aspect, a method for charging a mobile crane while the mobile crane is driving is provided. The mobile crane includes an internal combustion engine. The method includes using energy of the internal combustion engine to drive the mobile crane and charging the battery of the mobile crane via a generator. A desired state of charge (SoC) of the battery when the mobile crane arrives at a target destination is defined and a charging power rating required of the internal combustion engine for charging the battery is calculated and provided to the generator such that the battery can be charged starting from its current state of charge, such that the desired state of charge of the battery is available at a calculated arrival time of the mobile crane.

The desired state of charge of the battery when the mobile crane arrives at the target destination can be 80%, 90%, or 100%.

In another aspect, a method for operating a crane including at least one high-voltage battery-electric storage system in an emergency-operation mode when the high-voltage storage system is ineffective or not optimally effective is provided. The method includes precharging the high-voltage system via a low-voltage system and/or an external power feed to an on-board charger following voltage conversion to a DC high voltage necessary for operating the high-voltage system and operating the crane without activating the high-voltage battery.

The method for operating the crane can also include heating or cooling the high-voltage battery. The high-voltage battery is heated or cooled by a high-voltage thermal management system after the high-voltage system has been precharged and put into operation without connecting the high-voltage battery. The energy necessary for heating and cooling the high-voltage battery can be provided to the high-voltage system via an in-crane generator driven by an internal combustion engine or via an external power feed connected to the on-board charger.

In another aspect, a mobile crane is provided. The mobile crane includes a battery, a generator configured to charge the battery, and an internal combustion engine configured to drive the generator and move the mobile crane. The crane further includes a control unit configured to charge the battery of the mobile crane while the crane is driving.

The controller can be configured to charge the battery of the mobile crane while driving by using energy of the internal combustion engine to drive the mobile crane and charging the battery of the mobile crane via the generator. A desired state of charge of the battery when the mobile crane arrives at a target destination is defined and a charging power rating required of the internal combustion engine for charging the battery is calculated and provided to the generator such that the battery can be charged starting from its current state of charge, such that the desired state of charge of the battery is available at a calculated arrival time of the mobile crane.

The desired state of charge of the battery when the mobile crane arrives at the target destination can be 80%, 90%, or 100%.

The mobile crane can include at least one high-voltage battery-electric storage system. The controller can be further configured to operate the mobile crane in an emergency-operation mode when the high-voltage storage system is ineffective or not optimally effective by precharging the high-voltage storage system via a low-voltage system and/or an external power feed to an on-board charger following voltage conversion to a DC high voltage necessary for operating the high-voltage system and operating the mobile crane without activating the high-voltage battery.

The controller can also be configured to heat or cool the high-voltage battery with a thermal management system after the high-voltage system has been precharged and put into operation without connecting the high-voltage battery. The energy necessary for heating and cooling the high-voltage battery can be provided to the high-voltage system via an in-crane generator driven by the internal combustion engine or via the external power feed to the on-board charger.

### BRIEF DESCRIPTION OF THE DRAWINGS

FIG. 1 shows an example of a system architecture of a mobile crane.

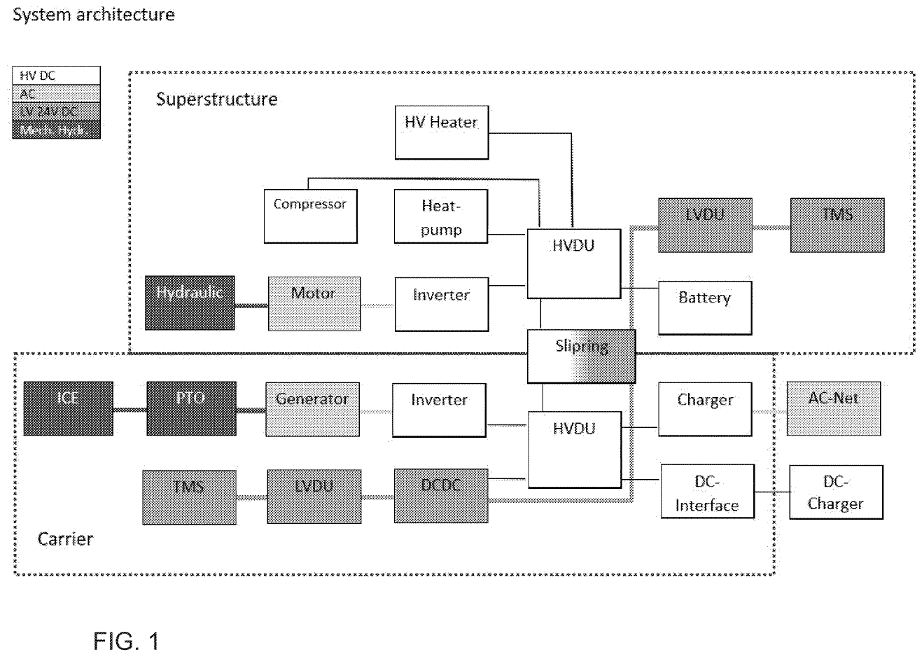

### DETAILED DESCRIPTION

### 1. Operating Modes for Charging the HV Battery

The HV battery can be charged externally, i.e., by means of an external power connector or an external power supply. Alternatively or additionally, the HV battery can be charged internally using a generator which is for example carried in the mobile crane. The charging options described below can for example be used.

1.1. Charging from an External Source

An external power connector for charging the HV battery of the mobile crane can for example be an alternating-current (AC) or direct-current (DC) power connector which is for example connected to a mains supply or fed from an external generator. AC charging is typically performed at lower power ratings, such that AC charging is slower overall than DC charging which uses a higher power rating and a higher current of for example over 200 A or 300 A, thus enabling comparatively faster charging.

AC charging can for example be performed as three-phase charging at 400V and 32 A or 64 A (typical plugs: IEC 62196-2 and IEC 62196-3 (AC type 2) or optionally SAE 3068 (AC type 2)).

The battery/batteries of the crane can for example be charged in situ from an external AC power source AC-net via an internal (optional) on-board charger of the mobile crane, wherein an operator can for example set the maximum charging current suitable for the mains supply available and the battery. Typical values for this maximum charging current are in the range of 1 to 64 A. An operator can also define a limit or restriction on the maximum state of charge (maximum % AC) in order to protect the battery and extend its service life. These data or presets can be taken into account by a control system of the charger when charging the battery.

DC charging can for example be performed at up to 800V and up to 200 A or 300 A (typical plugs: IEC 62196-2 and IEC 62196-3 (DC type 2) or optionally SAE 3068 (DC type 2)).

The battery/batteries of the crane can for example be charged in situ from an external DC power source (“DC-Charger”) via an internal charging interface (“DC-Interface”) of the mobile crane, wherein the charging interface can for example communicate with the external charging device, wherein the external charging device can for example perform safety monitoring such as for example insulation measuring, etc.

In order to maintain or protect the HV battery and improve its overall service life, the state of charge of the HV battery can for example be set by means of a battery management system, such that the HV battery is never fully discharged (0%) and never fully charged (100%), i.e., a state of charge of the battery is for example set such that it is always between a minimum state of charge and a maximum state of charge, such as for example between 5% and 95% of the maximum HV battery charge, wherein this range of 5% to 95% of the effective state of charge of the HV battery can for example be displayed as 0% to 100% on a state-of-charge display.

As with AC charging, the operator can define a maximum desired state of charge (SoC) of the battery, in order to protect it and increase its service life.

When a charging cable is connected up to the crane, the crane control system prohibits the internal combustion engine from being started in order to prevent it from being unintentionally damaged.

A smart control unit (SCU) is an additional controller for the HV system and forms an intelligent control unit for controlling, monitoring and optimizing the battery operations, safety functions and power electronics of the drives, generator and thermal management system. The SCU can ensure the low voltage required for the system (for example 24V) via the HV battery and DC/DC conversion when an (AC or DC) process of charging the HV battery is being performed or when the battery is being conditioned, even when the low-voltage supply of the crane is not active.

If, for example, the ignition switch on the mobile crane is switched off and an AC or DC charging process is active and/or when battery conditioning is scheduled, the superstructure display ODM and the carrier display CDM can automatically display the battery information. In this operating state, all of the other crane functions are preferably blocked. During the AC or DC charging process and during battery maintenance or battery conditioning, the superstructure display ODM and the carrier display CDM preferably remain on automatically and show the relevant charge and battery status values, even when the mobile crane is switched off.

The superstructure display ODM and/or the carrier display CDM can display one or more or all of the following information on their screen during a charging process:
charging power rating (KW);
state of charge (SoC);
target state of charge (percentage of maximum charge to be reached when charging);
expected/calculated time at which the target state of charge will be reached;
target time (of day) at which battery conditioning or battery maintenance will be complete (if activated);
a warning symbol to indicate that the internal combustion engine ICE can only be started after the charging plug has been removed.

The state of charge (SoC) then quantifies the remaining available capacity of a battery at a particular point in time, including for example in relation to a particular state of health (SoH). The state of charge (SoC) can be expressed as a percentage (0%=empty; 100%=full). An alternative form of this display can also be the depth of discharge which indicates the percentage of the nominal capacity of the battery which can still be drawn without decreasing its service life.

It is preferably not possible to start the engine ICE when the HV battery is being charged via an external charging source or when an AC or DC charging cable is connected to the mobile crane or when a charging plug is inserted on the mobile crane. It is possible for the engine ICE to be automatically stopped, for example by a control system, when an AC or DC charging cable is connected to the mobile crane or when a charging plug is inserted on the mobile crane. To this end, it is also possible to additionally perform a speed check, i.e., the engine is for example only stopped when the speed of the mobile crane is below a defined speed. The defined speed can for example be 8 km/h. This can for example prevent the engine from being unintentionally switched off when the mobile crane is being moved at a speed above this defined speed.

It is possible for an operator of the mobile crane to manually interrupt the charging process at any time, for example by operating a corresponding switch.

In order to have available the best possible or full charging and discharging capacities of the battery, the battery of the mobile crane should be operated within particular temperature limits. The temperature range T within which the battery is operated should for example be between 5° C. and 30° C., i.e., 5° C.<T<30° C.

A battery conditioning mode is advantageously provided, in order for example to define a start time at which the crane is or is to be ready for operation, in which one or more batteries are for example at an optimum or favorable temperature, for example within the aforementioned temperature range T, at said start time. If the battery conditioning mode is activated, a desired “mobile crane start time” can for example be indicated, wherein a thermal management system TMS of the mobile crane then starts conditioning, i.e., for example cooling or heating, the batteries at a precalculated time in order to obtain the desired optimum or perfect conditions for the battery/batteries at said “mobile crane start time”, wherein the thermal management system TMS can take into account the ambient temperature and the current general state or operating state of the battery. The battery conditioning mode is also provided in order to achieve an optimum battery temperature for charging it at a defined time.

The superstructure display ODM and/or carrier display CDM can for example be designed as touchscreens or exhibit other input options which are known in their own right. The following battery conditioning parameters can be inputted by an operator by means of these input options:
the expected crane operating or charging start time;
activating (on/off) battery conditioning.

The mobile crane can include a HV heater and a heat-pump located within the superstructure of the mobile crane. The HV heater and heat-pump can be integrated into the high-voltage (HV) system and can be connected to a high-voltage distribution unit (HVDU).

The HV heater can be situated in the superstructure and can receive high-voltage direct current (HV DC) power directly from the HVDU. As part of the thermal management system, the HV heater can be used to provide heating. In particular, the HV heater can support the heating of the HV battery to maintain optimum operating temperatures (e.g., between 5° C. and 30° C.) and may provide cabin climate control via an air conditioning unit.

Like the HV heater, the heat-pump is located in the superstructure. The heat-pump is also electrically connected to the HVDU to draw HV DC power. The heat-pump can work alongside a compressor and the thermal management system. The heat-pump can regulate temperatures within the crane's systems, assisting in either heating or cooling processes required for battery conditioning or maintaining the superstructure's environment.

The HV heater and heat-pump are particularly useful for the battery conditioning mode. As described above, the operator can define a mobile crane start time. At this point, the thermal management system can use the HV heater and heat-pump to pre-calculate and achieve the desired temperature for the batteries. This assists in ensuring the battery has the best possible charging and discharging capacities before operation begins.

### 1.2. Charging Using a Generator (ICE)

The HV battery of the mobile crane can be charged, in situ or while driving, using a generator of the mobile crane which is driven directly or indirectly by a (diesel) engine of the mobile crane.

When charging the battery in situ (i.e., when the mobile crane is not moving and is resting on its tires or outriggers), the intention is generally to charge the battery as quickly as possible, wherein the crane is normally not in operation. When charging the battery while driving, the intention is generally to arrive at the site of operation for the mobile crane with the “best possible” charge on the battery, i.e., for example a fully charged battery or a charge corresponding to a desired state of charge (SoC) which is for example defined by an operator.

An operator can interrupt this charging process at any time and switch to another operating mode.

### 1.2.1 Charging In Situ

In a process of charging the HV battery using a generator, the generator can be coupled to the engine via a power take-off PTO, wherein the transfer gearbox can for example be set such that the power take-off PTO is active and the vehicle drive is in neutral.

The drive gearbox can be set to an optimum gearing ratio, for example a 16^{th} gear, in order to operate the generator at an efficient speed.

The engine ICE is preferably operated at an efficient charging speed, such as for example 1,450 revolutions per minute (rpm).

The generator is operated in a torque mode, wherein the torque is determined or set by a controller of the system such that it matches a permissible charging current of the HV battery, preferably on the basis of or in accordance with the state of charge (SoC) of the HV battery and the battery temperature or system temperature.

A control system can optionally also be designed such that charging is performed more economically, wherein the charging time is extended. The (diesel) engine ICE can for example be operated at a lower rotational speed, such as for example 1,000 revolutions per minute.

1.2.2 Charging while Driving

It is possible to charge the battery while the crane is moving, i.e., while driving, wherein the generator is driven by the internal combustion engine ICE in order to charge the battery.

An operator can choose between the subordinate modes described below (maximum charging-time-optimized charging; ECO charging; Drive Pro) and switch between them while driving.

The transfer gearbox is set such that the power take-off PTO is active and the mobile crane can be simultaneously driven or moved. This can be achieved using a normal drive and/or gearing ratio or an off-road gear and/or gearing ratio, wherein the drive gearbox can be operated as usual.

The power take-off PTO can be directly coupled to the drive train, wherein the generator speed is linearly coupled to the drive speed of the mobile crane.

The generator can be operated in a torque mode, wherein the torque is determined or set by a controller of the system such that it matches a crane speed, engine output utilization, accelerator pedal position, the active gear of the drive gearbox and/or a permissible charging current of the HV battery, preferably on the basis of or in accordance with the state of charge (SoC) of the HV battery and the battery temperature or system temperature, wherein it is possible to take into account which of the modes described below is set.

The generator torque can be set to 0 Nm when the ABS or brake control system is active.

The generator torque can be set to be positive or negative, wherein the system is also capable of transmitting a drive output from the generator to the drive train of the mobile crane, i.e., the generator can be driven by the engine, in order to charge the HV battery, and can act in another operating mode as an electric motor which is supplied with energy by the HV battery in order to in turn drive the drive train (drive support), so as to for example act as an enhancement or boost for the internal combustion engine when additional engine output is required, such as for example when overtaking or driving uphill.

### 1.2.2.1. Full or Maximum Charging Mode

In the “full or maximum charging” mode, the intention is to charge the battery as quickly as possible to an intended or defined full or partial state of charge (SoC).

An operator can stop this mode or switch to another mode if the crane is not moving.

The drive support described above is switched off in this mode.

The generator is operated at the maximum possible torque and receives power while the mobile crane is accelerating, driving, coasting and braking, as long as the internal combustion engine ICE output utilization is below a definable specific value of for example <90%.

The maximum possible drive output of the mobile crane remains unchanged if the power utilization of the internal combustion engine ICE for the generator is above a specific value of for example 90%, wherein the generator torque can then be or is then incrementally decreased to 0 Nm.

The power take-off PTO is switched off and/or disconnected from the drive train when the target state of charge (SoC) of the battery is reached.

Adaptive recuperation modes can optionally be set by an operator. An operator can for example define when or the degree to which recuperation is to be implemented.

### 1.2.2.2. ECO Charging Mode

In the “ECO charging” mode, a good balance or relationship is to be set between the battery charging time and the consumption of the internal combustion engine ICE.

The drive support described above is switched off in this mode.

The generator receives power while the mobile crane is coasting and braking and is operated at the maximum possible torque.

The generator is operated at a lower torque (or no torque) and receives less power while the mobile crane is accelerating and driving at a constant speed.

The maximum possible drive output of the mobile crane remains unchanged if the internal combustion engine output utilization for the generator is above a specific value of for example 90%, wherein the generator torque can then be or is then incrementally decreased to 0 Nm.

The power take-off PTO is switched off and/or disconnected from the drive train when the target state of charge (SoC) of the battery is reached.

Adaptive recuperation modes can optionally be set by an operator. An operator can for example define when or the degree to which recuperation is to be implemented.

### 1.2.2.3. Drive Pro Balance Mode

In the “Drive Pro” balance mode, a good balance is established between the battery charging time and the handling of the mobile crane. The elasticity of the crane drive at medium-to-high speeds is increased. The system output of the drive train is increased.

The generator receives power while the mobile crane is accelerating, driving, coasting and braking and is operated at the maximum possible torque as long as the internal combustion engine output utilization is below a specific definable value of for example <90%.

The generator functions as an engine and draws energy from the battery and provides torque to the drive train while the mobile crane is accelerating and driving at a high engine utilization of for example >90% and an advanced accelerator pedal position of for example >90% depressed. However, this function is not active when driving with cruise control.

The support torque provided to the drive train by the generator is determined by the system on the basis of the state of charge, the system temperature, the accelerator pedal position and the internal combustion engine utilization.

The maximum drive output of the mobile crane is increased by the generator acting as an electric motor. If the crane speed is above a specific definable value of, for example, greater than 84 km/h, the generator support torque is decreased to 0 Nm.

The power take-off PTO is not deactivated when the target state of charge (SoC) is reached.

The system issues an alert if the drive support is restricted, for example due to the state of charge (SoC), temperature or other parameters.

### 2. Operating the Crane

The hydraulic pump (for example a variable-displacement axial piston) of the hydraulic system of the superstructure of the mobile crane is driven by an electric motor which is preferably an HV alternating-current synchronous motor. The variable displacement is controlled by a hydraulic load-sensing system. Another embodiment would be a constant-volume hydraulic pump in which the required volume is regulated via the rotational speed of the electric motor.

The following procedure is for example performed when the crane is in active operation:
The engine is switched off if a crane drive is or remains inactivated for a specific defined period of for example three seconds and all of the hydraulic brakes are in their braking position for a specific defined period of for example one second.
The engine is in neutral, for example at 300 or 500 revolutions per minute, in order to provide the system pressure, in order for example to release the brakes, activate valves, etc. when the crane drive is active and an initial speed is not defined or stored.
If an initial speed is defined or stored, the engine will run at this speed if the crane drive is active.
The speed can be increased or reduced by an operator, and the value defined by the operator is stored for the current normal operation until the crane is switched off (operating mode=off).
The speed can be increased but not reduced by a pedal. The pedal only increases the speed if its position is pressed further than the position corresponding to the current speed (i.e., pedal position>current speed). This speed value is not stored, i.e., when the pedal is released again, the crane returns to the last speed value stored.
The system calculates the maximum battery output available to the engine on the basis of the state of charge (SoC), temperatures, etc. The maximum output thus ascertained, including braking capacity, is taken into account hydraulically by reducing the setpoints of the respective hydraulic systems if necessary, i.e., if the maximum battery output available is too low (a setpoint is the control command from an operator, for example by means of a joystick). This mainly applies when more than one main drive is requisitioned or activated by an operator.
Battery output utilization and the remaining power rating are indicated on a display (UI=user interface) of the crane control system.
An automatic speed control system can function as follows. The required hydraulic output is calculated by the crane control system CCS, from which the required speed of the electric motor is calculated. This required speed forms the basis for calculating the actuation of the inverter of the electric motor in order to implement the calculated necessary change in speed by correspondingly actuating the electric motor, i.e., the setpoint of the crane control system CCS is the speed of the electric motor or change in the speed of the electric motor required in order to achieve the defined hydraulic output.
A hydraulic pump can for example be driven all-electrically (battery and/or external power source and/or generator) and can be driven by the electric motor at any time and at any rotational speed.
The electric motor is switched off if for example the crane is not operated and the drive mechanisms of the crane are actively braked for three seconds.
The electric motor is operated at an idling speed when the system pressure is to be maintained (i.e., the drive mechanism of the crane is active, but output is not requisitioned).
(Peak) operation of the electric motor is dependent on the maximum discharge output of the battery (i.e., dependent for example on the state of charge (SoC), temperature, etc.)
The setpoint/operator command is not implemented 1:1, but rather only in accordance with the peak power capacity of the battery (i.e., it may be throttled).

### 2.1 ECO Diesel ICE Mode

This mode is automatically activated when the operator switches to operating the crane while charging by way of a generator is active. This mode can also be activated manually.

The transfer gearbox is switched to active power take-off and into neutral.

The drive gearbox is switched to an optimum gearing ratio, for example a 16^{th} gear, in order to operate the generator at an efficient speed.

It is possible to start the internal combustion engine ICE in this mode.

The crane is operated on battery power, with the option of recharging the battery using the generator. The battery charge can for example be less than or equal to a 20% state of charge (SoC) when operations commence and greater than or equal to a 90% state of charge (SoC) when operations are terminated.

A visual and/or audible signal is issued when the battery requires recharging. For safety reasons, the internal combustion engine ICE is only started once this is confirmed by an operator. If sufficient safety functions are provided, this process can be automated.

If a remote control is active, it is possible to start the engine, wherein a warning signal such as for example a beeping signal is activated when a request to start the internal combustion engine ICE is made.

If the control system is activated from the operator's cab, the internal combustion engine continues to run and the generator is set to a lower torque or to 0 Nm.

### 2.2 Battery Mode

In the battery mode, it is not possible to start the internal combustion engine ICE.

A visual and/or audible warning is issued to the operator if the state of charge (SoC) of the battery falls below a defined first threshold of for example 15%. The system output is then reduced, but the mobile crane remains fully functional.

A subsequent (second) warning is issued if the state of charge (SoC) of the battery falls below a defined second threshold of for example 8%. The system output is then restricted: a maximum speed of the electric motor is, for example, not possible.

Another (final) warning is issued if the state of charge (SoC) of the battery falls below a defined third threshold of, for example, 2%. Operating the crane is then stopped in a stable state. The hydraulics are only then operated in neutral.

If a remote control is active, a warning signal such as, for example, a beeping signal is activated in order to inform the operator that the output of the mobile crane has been reduced or stopped.

### 2.3. AC or DC Cable-Operated Battery Mode

In the AC or DC cable-operated battery mode, it is not possible to start the internal combustion engine ICE.

This mode is automatically activated when an (AC or DC) charging cable is connected to the mobile crane.

Continuous charging is performed with a lower hysteresis when a maximum state of charge (SoC) of the battery is reached.

A visual and/or audible warning signal is issued if the state of charge (SoC) of the battery falls below a defined first threshold of, for example, 15%, and the system output is reduced or restricted, but the mobile crane is fully functional.

A subsequent (second) warning is issued if the state of charge (SoC) of the battery falls below a defined second threshold of, for example, 8%. The system output is then restricted: a maximum speed of the electric motor is for example not possible.

Another (final) warning is issued if the state of charge (SoC) of the battery falls below a defined third threshold of, for example, 2%. Operating the crane is then stopped in a stable state. The hydraulics are only then operated in neutral.

If a remote control is active, a warning signal such as, for example, a beeping signal is activated in order to inform the operator that the output of the mobile crane has been reduced or stopped.

### 2.4 Emergency-Operation Mode

The emergency-operation mode is activated if the HV battery is non-functional, i.e., the main electrical power supply has failed, or ineffective because the battery temperature is too low or too high. The crane can only be operated to a limited extent in this mode.

It is possible to start and operate the system without an HV battery. This is supported by the LV (for example 24V) on-board mains supply or by a charging power source which is connected up. To this end, the HV system is supplied and precharged with the necessary high voltage by a DC/DC voltage converter which is fed via the 24V on-board mains supply of the crane in order to enable the generator to be operated. Alternatively, the on-board charger OBC is supplied with power via a charging power source connected up to the charging interface of the crane, wherein the on-board charger OBC in turn precharges the HV system and thus enables it to be operated.

The transfer gearbox is set to active power take-off PTO and into neutral.

The drive gearbox is switched to an optimum gearing ratio, for example a 16^{th} gear, in order to operate the generator at an efficient speed.

It is possible to operate the crane stably, which is supported or supplied by the generator which exhibits a restricted output as compared to the HV battery. Ramping up the individual crane functions takes longer, and the drive speed is reduced. All of the crane functions are thus possible but subject to restricted output and/or ramping-up.

Movements into stable states of the mobile crane are preferably possible.

The emergency-operation mode is also used to heat and/or cool HV batteries which are ineffective or deactivated, because the battery temperature is too low or too high, by way of the thermal management system operated in emergency-operation mode, thus bringing said temperatures within an operating temperature range necessary for operating the crane.

For example, in an emergency-operation mode the HV heater and heat-pump (as part of the thermal management system) can be powered even if the high-voltage battery is non-functional or deactivated. This is useful for heating or cooling an ineffective battery back into its required operating temperature range.

List of reference signs:

| | |
|---|---|
| Battery | battery system consisting of individual Li-ion battery packs |
| | including battery management system and a cooling circuit |
| Battery Pump | cooling-water electric pump for the battery circuit |
| Carrier | carrier of the crane |
| CCS | existing crane control system from the diesel-hydraulic |
| | “standard crane” |
| CDM | carrier display |
| Charger | AC three-phase to HV-DC on-board charger |
| | (connected to external AC mains supply) |
| Compressor | HV coolant compressor for the superstructure air conditioning unit |
| DC-Interface | interface for connecting the HV DC mains to an external DC fast |
| | charger |
| DC/DC | HV-DC to low-voltage DC bidirectional voltage converter |
| Generator | HV permanent magnet synchronous motor as a generator |
| HVDU | HV distribution unit (distribution and safety unit) |
| HV heater | heater for heating the HV battery |
| Heat-pump | temperature regulator for heating or cooling the crane's systems |
| ICE | diesel engine |
| Inverter | HV inverter for actuating the engine or generator |
| LVDU | low-voltage distribution unit |
| Motor | HV permanent magnet synchronous motor |
| ODM | superstructure display |
| PTO | power take-off on the transfer gearbox |
| SCU | additional controller for the HV system |
| Slipring | slip ring body for transmitting HV, low voltage, signals and CAN |
| | bus |
| SoC | state of charge (of the HV battery) |
| Superstructure | superstructure of the crane |
| TMS | thermal management system |

1. A method for charging a battery of a mobile crane while the mobile crane is driving, wherein the mobile crane comprises an internal combustion engine, the energy of which is used to drive the mobile crane and to charge the battery of the mobile crane by means of a generator, characterized in that the desired state of charge (SoC) of the battery when the mobile crane arrives at its destination is defined and the charging power rating required of the internal combustion engine for charging the battery is calculated and provided to the generator such that the battery can be charged, starting from its current state of charge, such that the desired state of charge of the battery is available at the calculated arrival time of the mobile crane.

2. The method according to claim 1, wherein the desired state of charge (SoC) of the battery when the mobile crane arrives at its destination is 80%, 90% or 100%.

3. A method for operating a crane comprising at least one high-voltage battery-electric storage system in an emergency-operation mode, wherein the high-voltage storage system is ineffective or not optimally effective, for example because the battery temperature is too low or too high, wherein the high-voltage system is precharged by means of the low-voltage system and/or an external power feed to an on-board charger (in-crane charger) following voltage conversion (DCDC) to a DC high voltage necessary for operating the high-voltage system and put into operation without activating the high-voltage battery for this purpose.

4. The method according to the preceding claim, wherein the high-voltage battery is heated or cooled by a high-voltage thermal management system after the high-voltage system has been precharged and put into operation without connecting the high-voltage battery, wherein the energy necessary for this is provided to the high-voltage system via an in-crane generator driven by an internal combustion engine (ICE) or via an external power supply connected to an in-crane (on-board) charger.

5. A mobile crane comprising a battery, a generator which can charge the battery, and an internal combustion engine (ICE) which can drive the generator and move the mobile crane, characterized by a control unit for performing the method according to any one of the preceding claims.
